(19) United States
(12) Patent Application Publication
(10) Pub. No.: US 2016/0142450 A1
(43) Pub. Date: May 19, 2016

(54) SYSTEM AND INTERFACE FOR DISTRIBUTED REMOTE COLLABORATION THROUGH MOBILE WORKSPACES

(71) Applicant: General Electric Company, Schenectady, NY (US)

(72) Inventors: Sharoda Aurushi Paul, San Ramon, CA (US); Joseph William Bolinger, San Ramon, CA (US); Raju Venkataramana, San Ramon, CA (US); Kumar Vipin Pandya, Tracy, CA (US)

(21) Appl. No.: 14/543,081

(22) Filed: Nov. 17, 2014

(51) Int. Cl. H04L 29/06; G06F 3/0482; G06F 3/0484; H04L 29/08; G06F 17/30

(52) U.S. Cl. CPC H04L 65/403; H04L 67/14; G06F 17/30575; G06F 3/04842; G06F 3/0482

(57) ABSTRACT

A system and method include a mobile workspace coupled to a communications network. The method includes providing a mobile workspace on a server, wherein the server is coupled to a communications network; providing a user interface including: two or more selectable media tools for communicating on the workspace, and one or more contacts, wherein the one or more contacts are selectable to participate in a synchronized communication session with a user on the mobile workspace. One or more contacts are selected to participate in the communication session with the user on the workspace. The one or more selected contacts are synchronized with the user on the mobile workspace, wherein each of the synchronized selected contacts and the synchronized user accesses the mobile workspace. The content is provided to the mobile workspace; and the content is stored to the mobile workspace on the server. Numerous other aspects are provided.

### FIELD

One or more embodiments described below relate to the electrical, electronic and computer arts, and more particularly, to remote collaboration and the like.

### BACKGROUND

Troubleshooting problems (e.g., problem solving) often involves an interaction between people experiencing the problem, and help-givers (e.g., people solving the problem). In an industrial setting, the person experiencing the problem may be a technician, and the help-giver may be a formal information source at a location remote from the technician. Problem solving may also involve informal information sources such as conversations with peers that result in knowledge sharing.

Systems and methods are desired which provide efficient mobile troubleshooting and collaboration.

### SUMMARY

In accordance with an embodiment of the invention, a system is provided. The system includes a mobile workspace coupled to a communications network, the workspace comprising: an interface including: two or more selectable media tools for communicating on the workspace, and one or more contacts, wherein the one or more contacts are selectable to participate in a synchronized communication session with a user on the mobile workspace; wherein the interface is operative to: receive a user selection of one or more media tools for communicating on a workspace; receive a user selection of one or more contacts to participate in the communication session with the user on the workspace; receive content; a display including at least one of content, one or more selected contacts, an annotation toolbar, media tools, and a sharable canvas space; at least one processor to: synchronize the one or more selected contacts with the user on the mobile workspace, wherein each of the synchronized selected contacts and the synchronized user accesses the mobile workspace; and a memory to store the mobile workspace.

In accordance with another embodiment of the invention, a method is provided. The method includes providing a mobile workspace on a server, wherein the server is coupled to a communications network; providing a user interface including: two or more selectable media tools for communicating on the workspace, one or more contacts, wherein the one or more contacts are selectable to participate in a synchronized communication session with a user on the mobile workspace; selecting one or more contacts to participate in the communication session with the user on the workspace; synchronizing the one or more selected contacts with the user on the mobile workspace, wherein each of the synchronized selected contacts and the synchronized user accesses the mobile workspace; providing content to the mobile workspace; and storing the content to the mobile workspace on the server.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Other features and aspects of the present invention will become more fully apparent from the following detailed description, the appended claims and the accompanying drawings.

### BRIEF DESCRIPTION OF THE DRAWINGS

The construction and usage of embodiments will become readily apparent from consideration of the following specification as illustrated in the accompanying drawings, in which like reference numerals designate like parts, and wherein:

FIG. 1 illustrates a diagram of system architecture according to some embodiments;

FIG. 2 is a block diagram illustrating an internal architecture of a server device according to some embodiments of the present invention;

FIG. 3 illustrates a user interface according to some embodiments;

FIG. 4 is a flow diagram of a process according to some embodiments;

FIG. 5 illustrate a user interface according to some embodiments;

FIG. 6 illustrates a user interface according to some embodiments;

FIG. 7 illustrates a user interface according to some embodiments;

FIG. 8 illustrates a user interface according to some embodiments and

FIG. 9 illustrates a user interface according to some embodiments.

### DETAILED DESCRIPTION

Some individuals and industries provide mobile devices (e.g., smartphones, tablets and other consumer wearable devices) to users to enable mobile troubleshooting and mobile collaboration. Mobile collaboration and problem solving may involve communication using multiple modalities (e.g., voice, instant messaging, video conferencing), sharing of documents from various repositories and collaboratively creating content that may enable problem solving. However, collaborating remotely on tasks (e.g., troubleshooting issues) is challenging on mobile devices because the relevant data may be scattered throughout a variety of single purpose applications, for example, the relevant data may be difficult to access repeatedly if the collaboration extends beyond a specific amount of time, and switching between modalities of communication may not be easy. Accordingly, a mobile collaboration application implemented as a website and a mobile application (“app”) may be provided A technical effect of embodiments of the invention is to provide a mobile collaboration application that may be configured to generate a collaborative workspace that includes elements to facilitate collaboration. Embodiments of the invention may provide remote troubleshooting of problems in real time. In particular, the collaboration app employs a client-server architecture that combines media/communication tools with content sharing features in persistent workspaces, which exist and are accessible after the real-time collaborative communication session has ended. The workspaces support smooth transitions between peer-to-peer and multi-party collaboration as well as individual modes of working when users are offline or want to work in a loosely-coupled way. In “tight mobility,” collaborators are synchronized in real-time, while in “loose mobility,” collaborators independently access contents and share information while still cooperating with others.

As used herein, the term “smartphone” refers to any cellular phone that is able to perform many of the functions of a computer, typically having a relatively large screen and an operating system capable of running general- and specific-purpose applications. As used herein, the term “tablet” refers to a general-purpose computer contained in a single panel, typically using a touch screen as the input device capable of running general- and specific-purpose applications. However, other input devices (e.g., keyboard, mouse, etc.) may be coupled to the tablet for use as input devices. Tablets may typically come loaded with a web browser and a variety of applications (“apps”). As used here, the term “app” refers to a self-contained program or piece of software designed to fulfill a particular purpose.

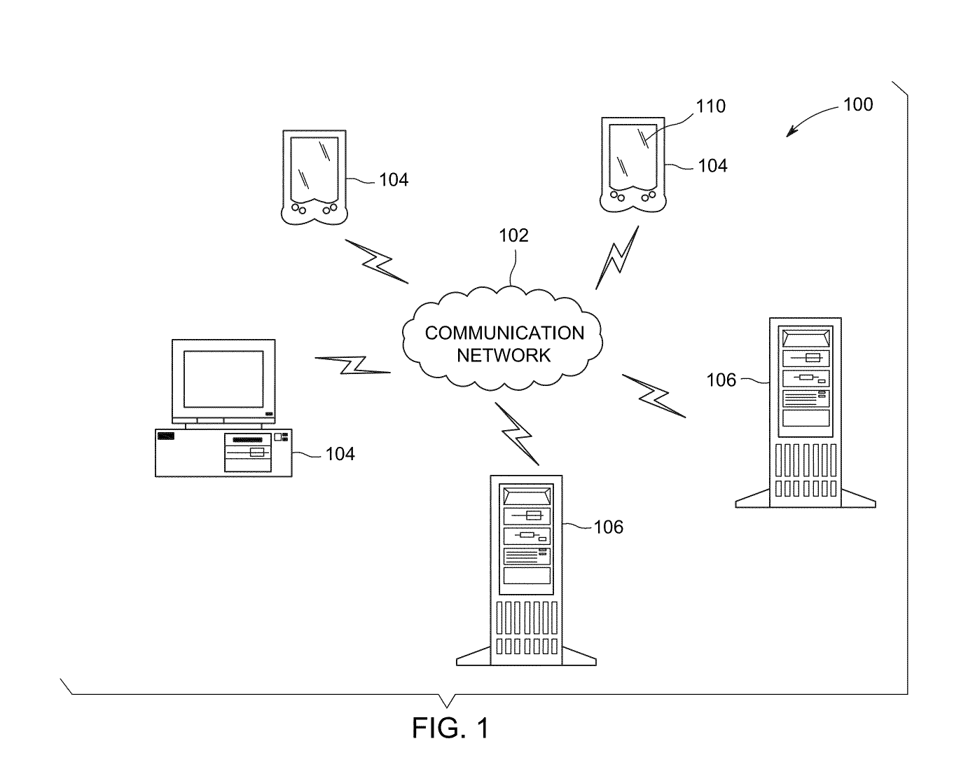

FIG. 1 is a block diagram of an example operating environment 100 in which a mobile collaboration application may be implemented, arranged in accordance with at least one embodiment described herein. The operating environment may include a communication network 102, in communication with one or more computing devices (including mobile computing devices—e.g., smartphones, tablets; PCs) 104, and one or more servers 106.

In general, the communication network 102 may include any number of different systems for transferring data, including one or more wide area networks (WANs) and/or local area networks (LANs) that enable the computing devices 104 and the servers 106 to communicate with each other. In some embodiments, the communication network 102 may include the Internet, including a global internetwork formed by logical and physical connections between multiple WANs and/or LANs. Alternately, or additionally, the communication network 102 may include one or more telephone networks, cellular networks, a fiber-optic network, a satellite network, an infrared network, a radio frequency network, any other type of network that may be used to transmit information between devices, and/or one or more wired and/or wireless networks such as, but not limited to Bluetooth access points, wireless access points, IP-based networks, or the like. The communication network 102 may also include servers that enable one type of network to interface with another type of network. Moreover, communication between communication network 102 and each of the depicted devices may proceed over any one or more currently or hereafter-known transmission protocols, such as Asynchronous Transfer Mode (ATM), Internet Protocol (IP), Hypertext Transfer Protocol (HTTP) and Wireless Application Protocol (WAP).

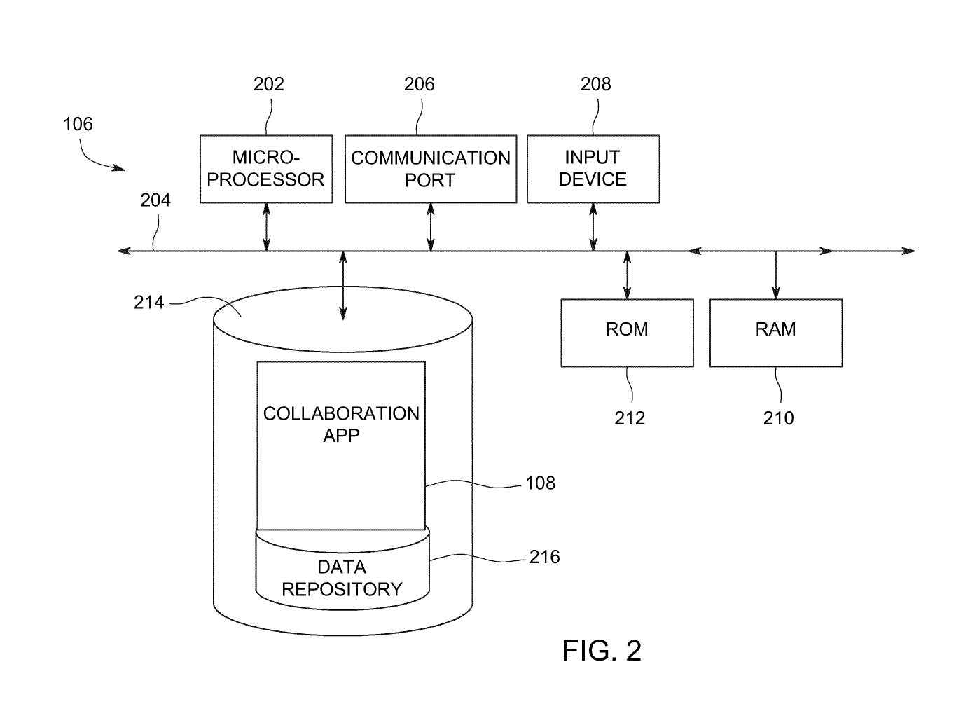

Each server 106 may provide at least one Web-accessible repository for storing and sharing a mobile collaboration application 108 (“collaboration app”) (FIG. 2), as described further below, and other resources among users. In some embodiments, each server 106 may store a single mobile collaboration application 108 that may be unique for the user creating the workspace with the application, as will be further described below. In other embodiments, each server 106 may store more than one mobile collaboration applications 108. For example, an organization may have multiple applications (e.g., multiple workspaces) stored on a single server. A single user may be authorized to access several collaboration apps 108, and therefore servers 106, and to thereby access and store electronic files maintained therein. Each server 106 may provide other services.

The mobile collaboration application 108 that is provided may, in general, be used to collaborate with remotely located contacts. The collaboration app 108 may have various components which are divided between the computing device 104 and the server 106. The various components are collectively referred to hereinafter as the “collaboration app 108.” Alternatively, the collaboration app 108 or equivalent functionality thereof may be provided in its entirety on the computing device 104, in which case the server 106 may be omitted.

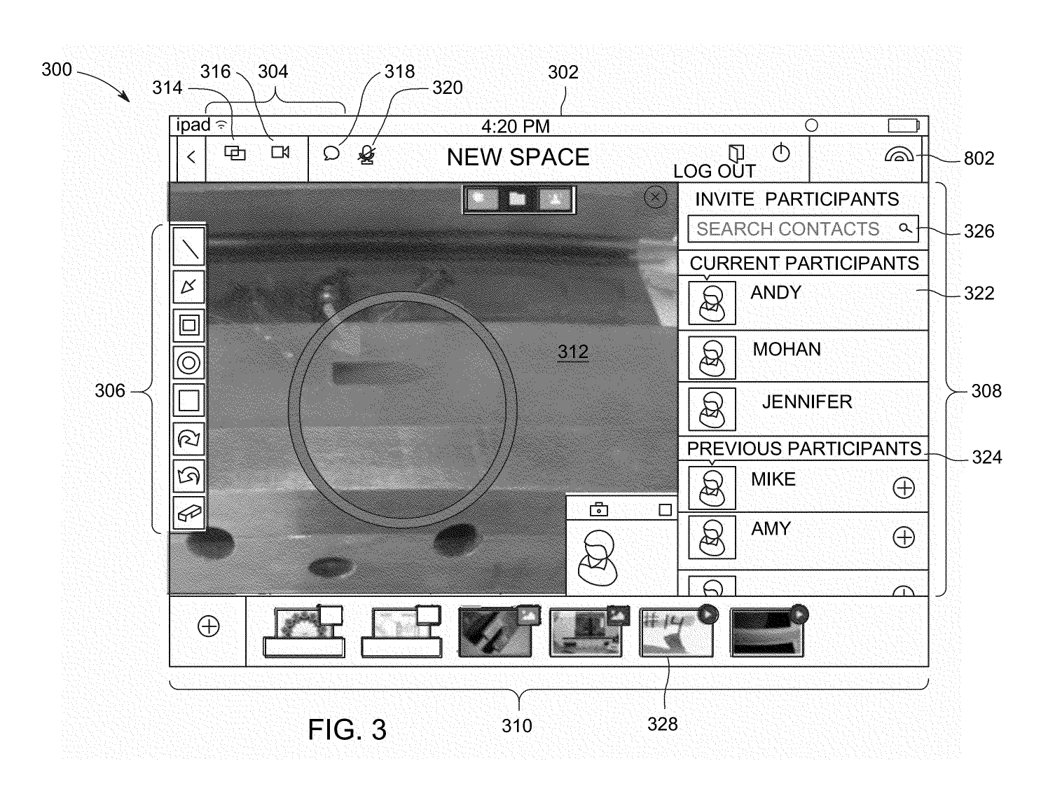

The computing device 104 may include, but is not limited to, a desktop computer, a laptop computer, a tablet computer, a mobile phone, a smartphone, a personal digital assistant (PDA), or other suitable computing device. The computing device 104 may include at least one display 110 for presenting a user interface 302 (FIG. 3). When the computing device 104 is implemented as a mobile device, such as a tablet computer or smartphone, the collaboration app 108 on the computing device 104 may be implemented as an app designed to run/execute on tablet computers, smartphones or other mobile devices. In these and other embodiments, the collaboration app 108 may communicate through the network 102 with the server 106 to cooperate with and perform one or more of the operations described herein.

Alternatively or additionally, the collaboration app 108 may be accessed on the computing device 104 via a browser (not shown) that communicates through the network 102 with the server 106 to download therefrom. In these embodiments, the collaboration app 108 is implemented as a runtime script that is executed in the browser in cooperation with the collaboration app 108 on the server 106 to perform one or more of the operations described herein.

Any of computing devices 104 may be used to access the collaboration app 108 stored in one of the servers 106, and additionally to store electronic files thereto according to some embodiments of the invention.

The devices of FIG. 1 may be connected differently than as shown, and some or all of the devices may be connected directly to one another. Of course, some embodiments of the invention include devices that are different from those shown. Although the devices are shown in communication with each other, the devices need not be constantly exchanging data. Communication may instead be established when necessary and severed at other times or always available but rarely used to transmit data. Moreover, although the illustrated communication links appear dedicated, it should be noted that each of the links may be shared by other devices.

FIG. 2 is a block diagram of an internal architecture of sever 106 according to some embodiments of the invention. As illustrated, the server 106 includes microprocessor 202 in communication with communication bus 204. The microprocessor 202 may comprise a Pentium™ microprocessor or other type of processor and is used to execute processor-executable process steps so as to control the elements of the server 106 to provide desired functionality.

Also in communication with the communication bus 204 is a communication port 206. The communication port 206 is used to transmit data to and to receive data from devices external to the server 106, such as computing devices 104. Such data may include, for example, any content added to the collaboration app 108. Any other suitable data may be transmitted/received. The communication port 206 is therefore preferably configured with hardware suitable to physically interface with desired external devices and/or network connections. For example, communication port 206 may comprise an Ethernet connection to a local area network through which the server 106 may receive and transmit information over the Web.

While information is typically input to the server 106 via the communication port 206, in some embodiments, the server 106 may also include an input device 208 in communication with the communication bus 204 to input information.

The server 106 may also include a RAM 210, connected to the communication bus 204 to provide the microprocessor 202 with fast data storage and retrieval. In this regard, processor-executable process steps being executed by the microprocessor 202 are typically stored temporarily in the RAM 210 and executed therefrom by the microprocessor 202. The ROM 212, in contrast, provides storage from which data can be retrieved but to which data cannot be stored. Accordingly, the ROM 212 is used to store invariant process steps and other data. One or both of the RAM 210 and the ROM 212 may communicate directly with the microprocessor 202 instead of over the communication bus 204.

In one or more embodiments, the server 106 includes a data storage device 214. The data storage device 214 stores, among other data, the collaboration app 108, and the processor executable process steps for executing the collaboration app 108. Data storage device 214 also includes a data repository 216 for storing electronic files/data associated with the collaboration app 108. In one or more embodiments, the collaboration app 108 communicates with data repository 216 to request and receive files therefrom and to store files therein.

The process steps stored in the data storage device 214 may be read from one or more of a computer-readable medium, such as a floppy disk, a CD-ROM, a DVD-ROM, a Zip™ disk, a magnetic tape, or a signal encoding the process steps, and then stored in the data storage device 214 in a compressed, uncompiled, and/or encrypted format. In alternative embodiments, hard-wired circuitry may be used in place of, or in combination with, processor-executable process steps for implementation of processes according to embodiments of the present invention. Thus, embodiments of the present invention are not limited to any specific combination of hardware and software.

Also stored in the data storage device 214 may be other unshown elements that may be necessary for operation of the server 106, such as an operation system, other applications, other data files, and “device drivers” for allowing the microprocessor 202 to interface with devices in communication with communication port 206. These elements are known to those skilled in the art, and are therefore not described in detail herein.

FIG. 3 is an outward view of a mobile workspace 300 presented on the display 110 according to some embodiments. More specifically, the computing device 104 may execute process steps in accordance with the collaboration app 108 to provide a user with access to the mobile workspace 300. In one or more embodiments, multiple collaborators/participants may annotate and share content while communicating using video, instant messaging, and screen sharing, for example, via the workspace 300. The workspace 300 may include a user interface 302 on the display 110, and the user may input information or receive information by the user interface 302. In one or more embodiments, the user interface 302 may include media tools 304, an annotation bar 306, a participant bar 308, a content bar 310 and a canvas 312, as will be described further below.

In one or more embodiments, the user interface 302 may include two or more user selectable media tools 304 for communicating on the workspace 300. The media tools 304 may include, for example, screen sharing 314, video 316, chat 318 and audio tools 320, for example. Other suitable media tools 304 may be used. Regarding the screen sharing tool 314, collaborators can take turns to share their screen and display to the other collaborators the content, such as photos and documents displayed on their screen. In some embodiments, the video tool 316 is in the form of a video channel that is solely associated with the particular workspace 300, and allows the collaborators to broadcast live videos (e.g., streaming video from a device camera). In one or more embodiments the chat tool 318 may provide the collaborators with a medium to exchange chat messages. Regarding the audio tool 320, an audio channel, akin to a teleconferencing line, may be solely associated with each workspace 300.

The annotation toolbar 306 may contain annotation tools such as freehand drawing, drawing of shapes, color selection, undo, redo, and erase. Other suitable annotation tools may be provided. In one or more embodiments, the annotation toolbar 306 may be accessible when a collaborator is viewing content, such as a document or picture, for example, which may be annotated. In one or more embodiments, the annotated content is automatically saved in the content bar 310. In one or more embodiments, the annotations may be color-coded, and additionally or alternatively labeled to provide authorship awareness/identification. For example, in FIG. 3, the item of interest on the canvas 312 is annotated via a circle and arrow, and a label indicating the author of the annotation is included.

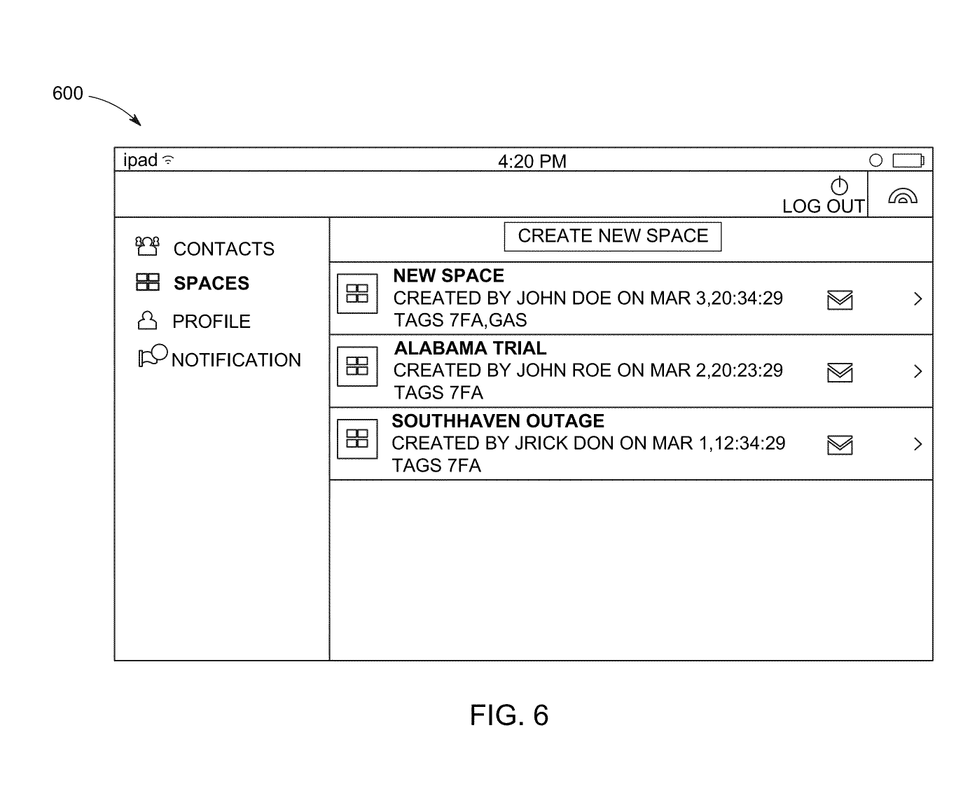

The participant bar 308 may include a list of current participants 322, who are participants currently viewing the workspace 300, a list of previous participants 324, who have previously participated in the workspace 300 but are no longer present in real time and a search field 326, which allows participants to invite additional participants. In one or more embodiments, when the user and participant(s) are participating in a communication session in real-time, per the Current Participant list, their communication may be referred to as “synchronized.” In one or more embodiments when the user or participant(s) is no longer participating in the communication session, this may be referred to as “asynchronous” communication or the user/participant is “disconnected” from the communication session. In one or more embodiments, the search field 326 allows searching for additional participants by name, role, or expertise keywords. Current participants may also invite a past participant to rejoin the workspace 300. As participants join and leave a workspace 300 (e.g., due to connectivity loss), they appear in the current and previous participants lists accordingly. In one or more embodiments, if a participant leaves a workspace, the participant may rejoin the workspace without being re-invited. In other words, the participant may not have to be re-invited to the workspace once they have been invited. In one or more embodiments, the participant may see the spaces they have participated in via the Spaces screen (FIG. 6) and can then join those workspaces. In one or more embodiments, the participant bar 308 provides awareness about the presence and identity of participants. In one or more embodiments, proximity techniques, such as video and screen-sharing icons in the Current Participant list 322 indicate who is sharing.

The content bar 310 may allow participants to add and share content 328 related to the collaboration issue. In one or more embodiments, the content 328 may include, for example, documents, images/photos, videos, comment(s), and audio file(s). Other suitable content may be included. In one or more embodiments, the collaborators have equal access rights to the content bar 310. In one or more embodiments, content 328 may be organized via at least one of collaborator ratings and comments, for example, related to the relevance of the content to the task at hand. In one or more embodiments, there may be no limit to the number of content objects 328 in the workspace 300. In one or more embodiments, a limit to the number of content objects 328 in the workspace may be a programmable parameter that may set by a user or an app developer, for example.

In one or more embodiments, the collaboration app 108 allows importing content 328 into the workspace 300 from external sources and allows exporting collaboration products to include in other workflows. In one or more embodiments, the collaboration products may be exported to any other computing device through email, for example.

Regarding adding content from an external source, a user is able to add a document or other content into the space for sharing from an external source, such as an internet browser (e.g., a website), a camera application on the computing tool 104, a photo gallery on the computing tool 104, or a document management app, for example. In one or more embodiments, once a user/participant clicks on the document/content in the external app, they have an option to open the content with the collaboration app 108. Selecting the collaboration app 108 launches the app 108 and provides the user/participants options to add the content to a new or existing space. The content appears in the content bar 310 of the selected space after addition.

Regarding exporting content, from the spaces screen 600 (FIG. 6), a user/participant can email content associated with a space by selecting the “email” icon next to a space, for example. In one or more embodiments, one or more pieces of content from the workspace are selectable, as are contacts to send the content to. In one or more embodiments, selection of the email icon launches the email app associated with the computing device 104, with pre-filled send-to names, per selection of the contacts, and attachments.

The canvas 312 is the area or space of the user interface 302 that is shared (“sharable space”) during the use of the screen-sharing tool 314. In one or more embodiments, the content 328 may be dragged and dropped into the canvas 312 from the content bar 310 for sharing and annotating via the annotation bar 306. In one or more embodiments, while sharing content 328 via the screen sharing tool 314, collaborators can use the video 316, chat 318 and audio 320 tools to communicate with other collaborators. An advantage that may be realized in the practice of some embodiments of the described systems and techniques is that having a single area for content sharing allows easy coordination of gaze and view focus.

The workspace 300 combines communication tools with content sharing in a single screen. In one or more embodiments, the workspace 300 employs mobile interaction design patterns such as infinite lists with scrolling, popovers, slideouts, and carousels.

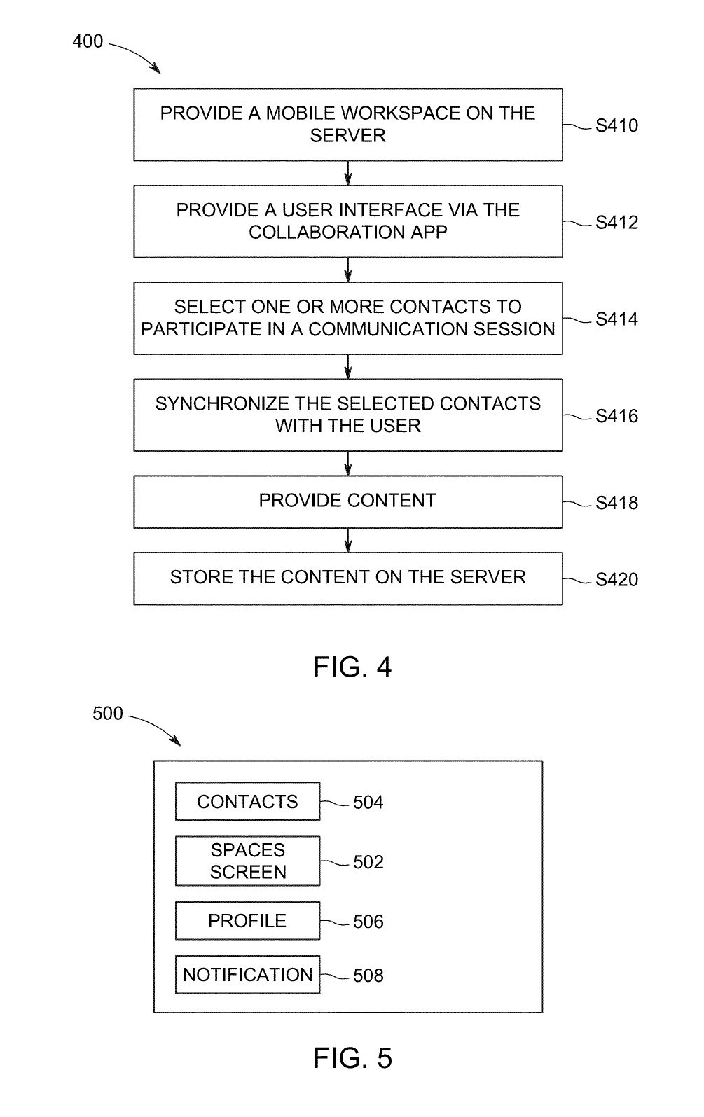

Turning to FIG. 4, in one example of operation according to some embodiments, FIG. 4 is a flow diagram of a process 400 according to some embodiments. Process 400 and other processes described herein may be performed using any suitable combination of hardware (e.g., circuit(s)), software or manual means. The process 400, in some embodiments, may be performed by at least one of the computing device 104 and the server 106, e.g., by execution of the collaboration app 108. In one or more embodiments, the computing device 104 is conditioned to perform the process 400, such that at least one of the computing device 104 and microprocessor 204 of the server 106 is a special purpose element configured to perform operations not performable by a general purpose computer or device. Software embodying these processes may be stored by any non-transitory tangible medium including a fixed disk, a floppy disk, a CD, a DVD, a Flash drive, or a magnetic tape. Examples of these processes will be described below with respect to the elements of the computing device 104, but embodiments are not limited thereto.

Initially, at S410, a mobile workspace 300 is provided via the collaboration app 108 on the server 106. In one or more embodiments, the server 106 is coupled to the communication network 104 and accessible thereby. In S412, the user interface 302 is provided to the workspace 300 via the collaboration app 108. As described above, the user interface 302 may include two or more user selectable media tools for communicating on the workspace, and one or more contacts. The one or more contacts are user selectable to participate in a synchronized communication session with a user on the workspace 300. Then in S414 one or more contacts are selected to participate in a communication session with the user on the workspace 300. Selection may be via highlighting, checkboxes, double-clicking, or any other suitable selection method. While the user and participants both use the workspace and collectively may be referred to as “collaborators,” to clarify the following explanation, the term “user” refers to the person creating the workspace 300 and the term “participant” refers to those of the contacts selected to participate in the communication session. Then in S416, the one or more selected contacts are synchronized with the user on the mobile workspace. As used herein “synchronous” means that the parties are in real-time communication with each other via the media tools 304, described above. In one or more embodiments, each of the synchronized selected contacts (participants) and the synchronized user accesses the mobile workspace. In S418, at least one content 328 is provided to the workspace 300. In one or more embodiments, the user may provide content 328 to the workspace 300 prior to synchronizing his with the participants. In one or more embodiments, the participants may provide content 328 to the workspace 300. In one or more embodiments, after the content 328 is added to the workspace 300, any of the collaborators may manipulate the content 328. For example, the content 328 may be annotated at least one of visually (e.g., a note or markings) and auditorily (e.g., an audible comment). In one or more embodiments, collaborators may add and view content 328 and navigate to other parts of the collaboration app 108 while another collaborator is sharing. The content 328 provided to the workspace 300 is stored on the server 106 in S420. An advantage that may be realized in the practice of one or more embodiments of the described systems and techniques is that once created, the workspace 300 and all content and annotations saved thereon persists after the communication session has ended in what is referred to as a “last synchronized view”. In one or more embodiments, the sessions may be saved every few minutes, for example. In one or more embodiments, the time period for saving a session may be user or programmatically defined. A collaborator is able to access the workspace 300 at any time. In one or more embodiments, a collaborator is able to access the “last synchronized view” of a workspace to view the history of annotations, content additions, etc. In one or more embodiments, the server 106 stores workspaces 300 as communication sessions and provides back-end services for communication and collaboration features.

The workspace 300 supports both online and offline use. The online mode refers to the real-time synchronized communication session. In one or more embodiments, in an offline mode, a collaborator may view the last-synchronized view of the past workspace 300. In some embodiments, in an offline mode, the participant information may not be viewed and real-time communication tools may not be accessed. In one or more embodiments, in an offline mode, content 328 may be added to the space 300, and this and older existing content may be annotated. In one or more embodiments, any changes made to a space 300 when offline are synchronized when the collaborator is online again. An advantage that may be realized in the practice of some embodiments of the described systems and techniques is that embodiments of the invention support tightly coupled collaboration in an online mode by providing real-time communication tools, and support loosely coupled collaboration in an offline mode.

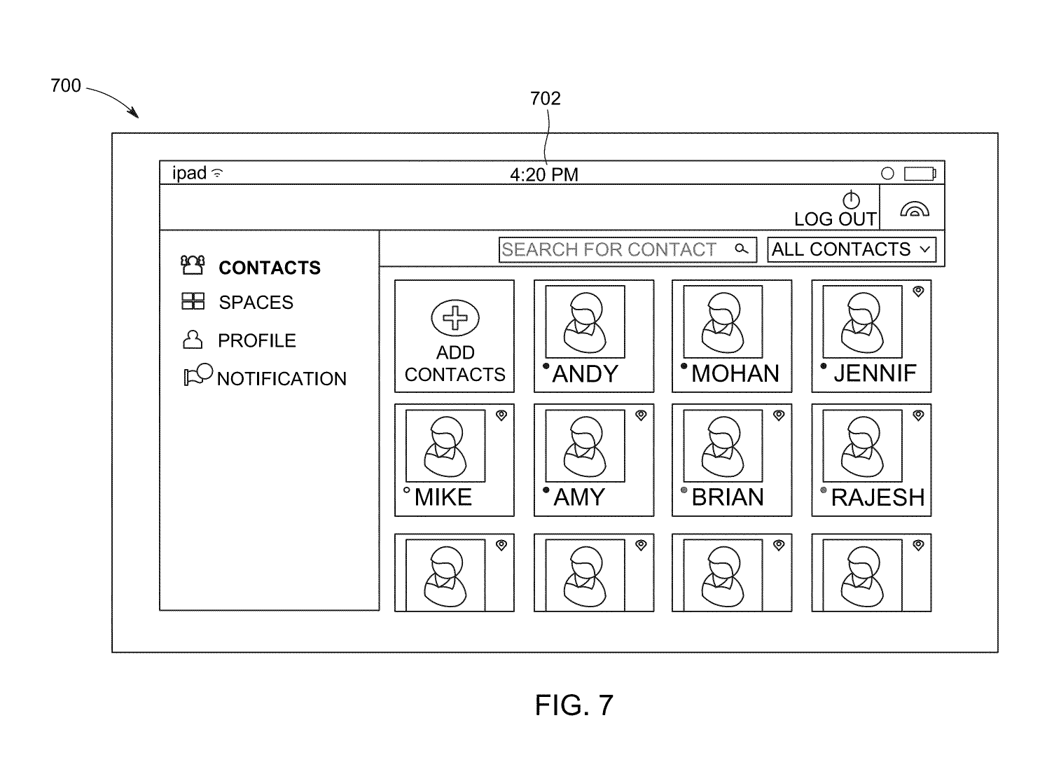

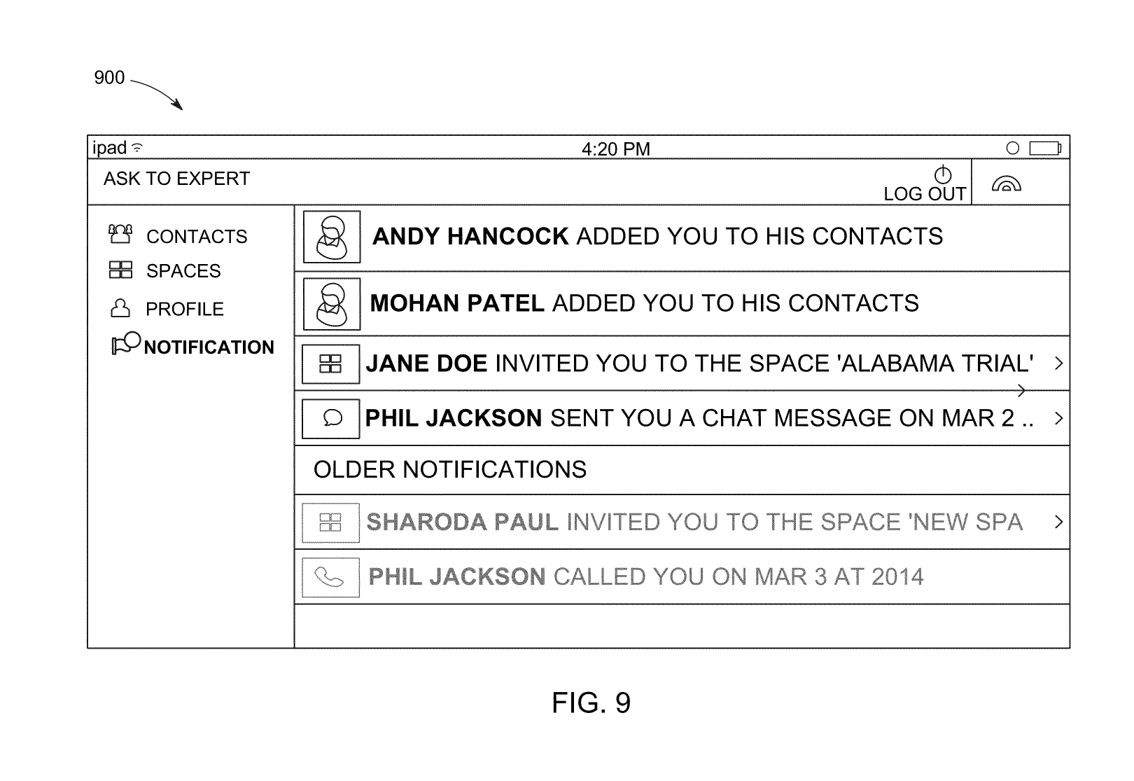

With regard to FIGS. 5-8 different user interfaces provided by the collaboration app 108 are displayed on the display 110 of the computing device 104. For example, when a user accesses the collaboration app 108 they may be presented with a home screen 500 allowing selection of one of a spaces screen 600 (FIG. 6) via a spaces button 502, a contacts screen 700 (FIG. 7) via a contact screen button 504, a profile screen (not shown) via a profile screen button 506 and a notification screen 900 (FIG. 9) via a notification screen button 508.

A spaces screen 600 is displayed in FIG. 6. The spaces screen 600 lists all of the workspaces a user has participated in in the past, and allows the user to create a new space. In one or more embodiments, the user is able to send some or all of the content of a previously created workspace to another participant. In one or more embodiments, the user may send some or all of the content of a workspace to any user of the collaboration app 108 or anyone else via email, for example. In one or more embodiments, at least one of users and participants may search at least one of the spaces they have participated in and a global pool of spaces to find related spaces and content, for example.

Participants may be added as the task progresses. After a workspace 300 has been created, the user may access the contacts screen 700 illustrated in FIG. 7. In one or more embodiments, the contacts screen 700 may be the first screen a user views when they log into the collaboration app 108. The contacts screen 700 may list all of the possible contacts/participants. The contacts screen 700 may enable users to build and manage their personal networks, in some embodiments. In one or more embodiments, the collaboration app 108 may suggest relevant experts and documents for a space 300 based on at least one of common problems, effective solutions and successful experts, for example. Other suitable criteria may be used to provide analytics-based recommendations. In one or more embodiments, for each contact, at least one of a name, role, expertise, and physical proximity to the user is displayed. Users may organize the contacts into groups based on task, site or other criteria, for example, in one or more embodiments. In one or more embodiments, the contacts screen 700 may indicate a contact's availability (such as, online presence) to participate in a space. In one or more embodiments, the collaboration app 108 is specific for a group of users, such that there may be different versions of the app/server. For example, a business unit may control the use of the server 106 with the collaboration app 108, such that the business unit includes in the contacts list the people authorized to access the system, and when the user creates the workspace, they select contacts out of the business-unit authorized list. The contacts screen 700 may include a search field 702 in one embodiments. The search field 702 may enable users to search the database of possible contacts by name, role, and expertise, for example.

A user may enter and edit profile information on the profile screen (not shown) after selection of the profile screen button 506. Profile information may be provided by employee databases. In one or more embodiments, users may enter keywords in their profile to describe their expertise.

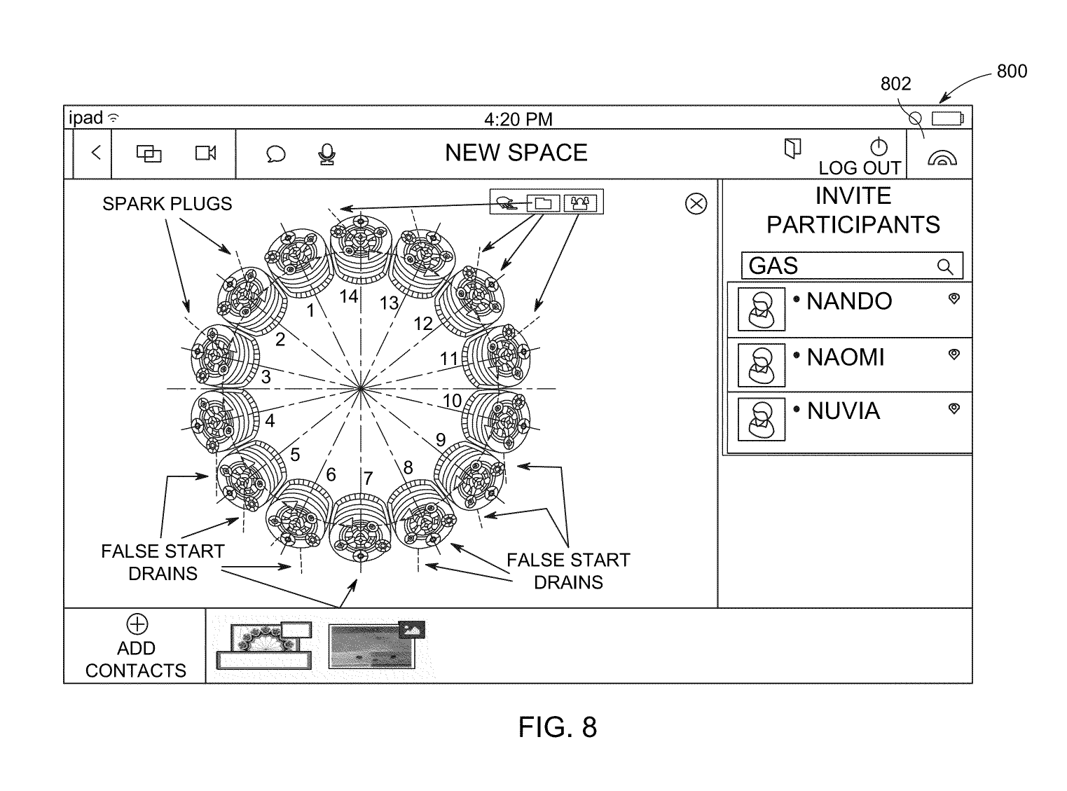

FIG. 8 provides a user interface 800 similar to the workspace 300 and user interface 302 described above with respect to FIG. 3. While in FIG. 3 the content 328 provided in the canvas 312 is a video and the video media tool 316 is the tool selected for sharing the user's video stream from a device camera, for example, in FIG. 8, the content 328 is a document, and the screen sharing tool 314 is selected for sharing content. As described above, to share document or image content, for example, in one or more embodiments users may select the screen-sharing tool, and to share a video, the video tool is selected in one or more embodiments. In one or more embodiments, the workspace 300 may include a video health indicator 802. The video health indicator 802 may show the user whether the network conditions are good for making video calls or not. The video health indicator 802 may advise the user of whether to use video calling, as poor network connectivity may degrade the video call quality and another media tool might be a better choice.

A notifications screen 900 is displayed in FIG. 9. In one or more embodiments, notifications may be provided via the notifications screen 900. Notifications may provide information to a user about other's actions. In one or more embodiments, notifications may be generated when a contact is invited to join a workspace or is added to another user's contacts. For example, when a user invites a contact to join a workspace 300, the invited contact receives a notification about the invitation. In one or more embodiments, all notifications may be saved and then displayed on the Notifications screen 900. In one or more embodiments, the user may view the notifications on the screen 900 and select one of the notifications at any time to launch the workspace associated with the notification. A notification screen 900 may log all notifications and display badges to indicate unread notifications, in one or more embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a contacts module, a media tool module, and a mobile workspace module. The method steps can then be carried out using the distinct software modules and/or sub-modules of the system, as described above, executing on one or more hardware processors 202 (FIG. 2). Further, a computer program product can include a computer-readable storage medium with code adapted to be implemented to carry out one or more method steps described herein, including the provision of the system with the distinct software modules

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A method comprising:
providing a mobile workspace on a server, wherein the server is coupled to a communications network;
providing a user interface including:
two or more selectable media tools for communicating on the workspace,
one or more contacts, wherein the one or more contacts are selectable to participate in a synchronized communication session with a user on the mobile workspace;
selecting one or more contacts to participate in the communication session with the user on the workspace;
synchronizing the one or more selected contacts with the user on the mobile workspace, wherein each of the synchronized selected contacts and the synchronized user accesses the mobile workspace;
providing content to the mobile workspace; and
storing the content to the mobile workspace on the server.

2. The method of claim 1, further comprising:
selecting at least one media tool.

3. The method of claim 2, wherein a media tool comprises an audio tool, a video tool, a chat tool, and a screen sharing tool.

4. The method of claim 1, further comprising:
storing a last synchronized view of the mobile workspace on the server.

5. The method of claim 4, wherein the last synchronized view of the mobile workspace persists after the communication session has ended.

6. The method of claim 4, wherein the last synchronized view of the mobile workspace includes content provided to the mobile workspace.

7. The method of claim 4, further comprising at least one of,
annotating the content on the last synchronized view of the mobile workspace; and
providing additional content to the last synchronized mobile workspace.

8. The method of claim 1, wherein the content provided on the mobile workspace comprises at least one of: a document, an image, a video, a comment, and an audio file.

9. The method of claim 1, further comprising:
manipulating the content provided on the mobile workspace.

10. The method of claim 9, wherein manipulating the content to the mobile workspace further comprises:
annotating the content at least one of visually and auditorily.

11. The method of claim 1, further comprising:
indicating on the workspace when at least one of the selected contact and the user is disconnected from the communication session.

12. The method of claim 1, further comprising providing a system, wherein the system comprises distinct software modules, each of the distinct software modules being embodied on a computer-readable storage medium, and wherein the distinct software modules comprise a contacts module, a media tool module, and a mobile workspace module;
wherein:
the selecting one or more contacts is carried out by the contacts module executing on at least one hardware processor;
the communication between the user and the one or more contacts is carried out by the media tool module executing on said at least one hardware processor; and
the synchronizing of the one or more selected contacts with the user to access to the mobile workspace is carried out by the mobile workspace module executing on said at least one hardware processor.

13. A system comprising:
a mobile workspace coupled to a communications network, the workspace comprising:
an interface including:
two or more selectable media tools for communicating on the workspace, and
one or more contacts, wherein the one or more contacts are selectable to participate in a synchronized communication session with a user on the mobile workspace;
wherein the interface is operative to:
receive a user selection of one or more media tools for communicating on a workspace;
receive a user selection of one or more contacts to participate in the communication session with the user on the workspace;
receive content;
a display including at least one of content, one or more selected contacts, an annotation toolbar, media tools, and a sharable canvas space;
at least one processor to:
synchronize the one or more selected contacts with the user on the mobile workspace, wherein each of the synchronized selected contacts and the synchronized user accesses the mobile workspace; and
a memory to store the mobile workspace.

14. The system of claim 13, further comprising a plurality of distinct software modules, each of the distinct software modules being embodied on a computer-readable storage medium, and wherein the distinct software modules comprise a mobile workspace module and an annotation module;
wherein:
the at least one processor is operative to synchronize the one or more selected contacts with the user on the mobile workspace, wherein each of the synchronized selected contacts and the synchronized user accesses the mobile workspace by executing the mobile workspace module.

15. The system of claim 13, wherein the media tool comprises an audio tool, a video tool, a chat tool, and a screen sharing tool.

16. The system of claim 13, wherein the last synchronized view of the mobile workspace persists after the communication session has ended.

17. The system of claim 14, wherein the at least one processor is operative to annotate content by executing the annotation module.

18. The system of claim 17, wherein the annotations are color-coded, and wherein the color indicates authorship of the annotation.

19. The system of claim 13, wherein the content on the last synchronized view is annotated after the communication session has ended.
